(19) United States
(12) Patent Application Publication
(10) Pub. No.: US 2010/0299032 A1
(43) Pub. Date: Nov. 25, 2010

(54) CONTROL ENGINE SPEED WITHIN A MACHINE

(75) Inventor: Neil A. Roth, Germantown Hills, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: CATERPILLAR INC., Peoria, IL (US)

(21) Appl. No.: 12/809,714

(22) PCT Filed: Dec. 16, 2008
(86) PCT No.: PCT/US2008/013762

§ 371 Date: Aug. 3, 2010

(30) Foreign Application Priority Data
Dec. 21, 2007 (EP) 07123919.8

(51) Int. Cl. G06F 19/00

(52) U.S. Cl. 701/50

(57) ABSTRACT

An apparatus and a method for controlling an engine are disclosed. Control means (122) may control a power output of an engine (102) configured for propelling a machine. Detection means (128) may detect a reverse driving direction operation of said machine. The control means are arranged for controlling the power output of said engine in response to detecting said reversed driving direction operation.

### TECHNICAL FIELD

The present patent application generally relates to controlling the power output of an engine propelling a machine. The application relates for example to controlling the power output of an engine of a hydraulic work machine.

### BACKGROUND

Power control systems for hydraulic work machines, for example track type tractors, track type loaders, excavators and the like, are known in the art. Also, power control systems for controlling the tracks, wheels, tires are known. The propulsion as well as drive and mobility functions of machines are controlled in the art. For example, from U.S. Pat. No. 5,967,756, there is known an apparatus for controlling an electro hydraulic system of a work machine having an engine that propels a variable displacement pump. The hydraulic system may be driven using an engine for driving the hydraulic pump and a hydraulic motor. Variable displacement pumps are typically used to provide hydraulic power the hydraulic system. The hydraulic motors may drive a plurality of work elements, also known as worktools, which may include drive system, blades, rippers and other types of work elements. For example, work elements like excavators, which may be useful in performing a large number of different and variant tasks, e.g., pipe laying, mass excavation, trenching, logging, and other tasks, may be driven by hydraulic motors propelled by the hydraulic power of a hydraulic system.

When operating the worktools, such as for example blades, rippers, and the like, hydraulic power requirements may be high. However, when the worktools are not in operation, the hydraulic power requirements are reduced, thus requiring only a reduced power input from the engine.

From U.S. Pat. No. 5,967,756, a variable displacement pump is used for controlling the hydraulic flow in the hydraulic system, thus being able to react on changing power requirements. Furthermore, engine speed setting is proposed in order to operate the engine at a desired rotational speed to input the desired power into the hydraulic system. The engine speed signal and the pump displacement signal are evaluated and optimum working points for the engine speed and the pump displacement are calculated.

The engine, also known as prime mover or machine, may input its energy into the hydraulic system by means of the hydraulic pump. The input energy within the hydraulic system needs to be regulated in terms of hydraulic motor speed, torque, power, and direction of rotation. In the hydraulic system, the pump connected to the engine generates hydraulic flow to drive the hydraulic motor, which is connected to the work tool, which may be understood as load, i.e. a power train of a drive system. In case the displacement of the pump and the motor are fixed, the input power from the engine is simply transmitted to the load. When using a variable displacement pump, a constant torque is possible. The torque of the hydraulic motor is constant at any period, because torque depends on fluid pressure and motor displacement. Increasing or decreasing pump displacement increases or decreases motor speed, respectively, while torque remains fairly constant. Therefore, the power at the hydraulic motor increases with increasing pump displacement.

Furthermore, it is possible to use a variable displacement motor with a fixed displacement pump. This configuration may produce a transmission that delivers a constant power. If the flow to the motor is constant, and the motor displacement is varied to maintain the product of speed and torque constant, the power delivered is constant. Decreasing motor displacement increases motor speed but decreases torque. This combination may maintain a constant power at the hydraulic motor.

Combining variable displacement pumps and variable displacement motors within a hydraulic system is also possible and allows for varying torque as well as power at the hydraulic motor.

Providing sufficient power from the engine to the hydraulic system is necessary within all applications. It is desirable to input the power required. Further, it is desirable to keep the input power as low as possible. The current disclosure is aimed at overcoming some or all of the disadvantages associated with the prior art.

### SUMMARY OF THE INVENTION

According to one aspect of the present application, an apparatus for controlling an engine is disclosed. Control means may control a power output of an engine configured for propelling a machine. Detection means may detect a reverse driving direction operation of said machine. The control means may be arranged for controlling the power output of said engine in response to detecting said reversed driving direction operation.

According to one other aspect of the application, a work machine adapted to control an engine is disclosed. The work machine may include control means for controlling a power output of an engine configured for propelling a machine. The work machine may further include detection means for detecting a reverse driving direction operation of said machine. Also, the work machine may include control means being arranged for controlling power output of said engine in response to detecting said reversed driving direction operation.

According to a further aspect of the application, a work machine including controlling the power output of a prime mover is disclosed. A work machine may include control means for controlling a power output of a prime mover configured for operating a machine. The work machine may further include detection means for identifying a reverse maneuvering operation of said machine. A control means may also be arranged for setting the power output of said prime mover in response to identifying said reverse maneuvering operation.

According to another aspect of the application, a method for controlling an engine is disclosed. The method may include controlling a power output of an engine propelling a machine. The method may include detecting a reverse driving direction operation of said machine. Also, the method may include reducing the power output of said engine in response to detecting said reverse driving direction operation.

Other features and aspects of this disclosure will be apparent from the following description and the accompanying drawings.

### BRIEF DESCRIPTION OF THE DRAWINGS

For a better understanding of the present application, reference may be made to the accompanying drawings in which:

FIG. 1 illustrates a block diagram of a hydraulic control system for a work machine;

FIG. 2 illustrates a further block diagram of a system of determining a desired engine speed setting;

FIG. 3 illustrates a graphical illustration of desired engine speed setting versus desired ground speed setting;

FIG. 4 illustrates a graphical illustration of speed setting versus a desired ground speed setting;

FIG. 5 illustrates a block diagram of a further hydraulic control system for a work machine;

FIG. 6 illustrates a further block diagram of another hydraulic control system for a work machine;

FIG. 7 illustrates a flowchart for operating a work machine according to embodiments.

### DETAILED DESCRIPTION

The present application provides for a control strategy for controlling the engine, also known as prime mover or machine, of the work machine, such that the engine speed setting is reduced, when the work machine is directed into reverse operation or in reverse operation. This may provide for improved engine efficiency and reduced engine noise in reverse operation. It has been found that during the return portion of the work cycle of the work machine, only a reduced performance of the hydraulic system is necessary. The work tools of the work machine, which are operated by the hydraulic system, are mostly used in forward motion of the work machine. In reverse motion, the worktools oftentimes are inactive or have reduced activity. In other words, in reverse operation of the work machine, the worktools only require reduced power within the hydraulic system.

The input power to the hydraulic system, input by the engine, may be reduced in reverse mode. Reducing the input power may be obtained by reducing the rotational speed of the engine driving the hydraulic pumps. The control of the engine, as well as the further below described mapping of ground speed setting to engine speed setting and dash speed setting to ground speed setting, may be activated and deactivated upon certain customers needs. It is possible, to activate the control strategy user driven.

The described control strategy provides for reduced fuel consumption, as it has been found that work machines may be operated in reverse mode between 20 and 40% of overall operation time. Assuming 37% of reverse time, the fuel consumption may be reduced to up to 4%. A control strategy as will be described hereinafter allows for reducing the fuel consumption.

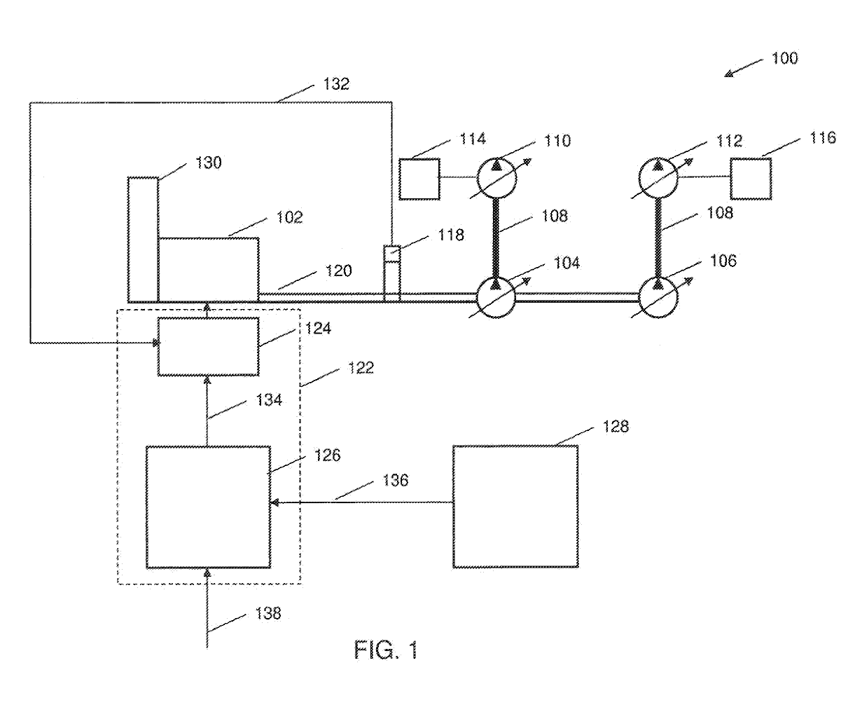

Reference is now made to FIG. 1 which illustrates a block diagram of a hydraulic system 100 of a work machine in accordance with the present application. The hydraulic system 100 may be applicable to any type of hydraulically or electro-hydraulically controlled work machine, for example track type tractors, track type loaders, excavators, or the like. The hydraulic system 100 may include an engine 102. The engine 102 may, for example, be a combustion engine, a hybrid engine or electrically driven engine, a solar engine, a fuel cell-engine, or the like. The engine 102 may also be known as prime mover or machine. The engine 102 may be understood as power source for the hydraulic system 100.

The engine 102 may drive one or more hydraulic pumps 104, 106. The pumps 104, 106 may be variable displacement pumps or fixed displacement pumps. The pumps 104, 106 may deliver fluid through high pressure ducts 108 to hydraulic motors 110, 112. The hydraulic motors 110, 112 may be variable displacement motors or fixed displacement motors.

The pumps 104, 106 provide for high fluid pressure within the ducts 108, for example between 40 and 500 bar. By means of the high fluid pressure within the ducts 108, hydraulic motor 110 may drive worktools 114. Worktools 114 may, for example, be blades, or rippers, or any other type of worktools capable of being operated by a hydraulic motor.

By means of the high fluid pressure within the ducts 108, hydraulic motor 112 may operate a drive system 116, for example crawlers or tires or any other means for providing forward and backward motion of the work machine.

The hydraulic system may further comprise an engine speed sensor 118. Engine speed sensor 118 may be arranged for sensing the rotational speed of the engine, for example, the rotational speed of the propeller shaft 120 by which engine 102 propels pumps 104, 106. The engine 102 may drive propeller shaft 120 at 0-4000 rpm. In common usage, the engine 102 may drive the propeller shaft 120 at 0-2500 rpm. By driving the propeller shaft 120, the engine 102 may propel the pumps 104, 106 in order to get the hydraulic system 100 into action and to provide for hydraulic pressure within ducts 108 to drive motor 110, 112.

Further illustrated are control means 122. Control means 122 may include an engine speed controller 124 and an engine speed setting unit 126.

Further illustrated are detection means 128. Detection means 128 allow detecting forward and reverse maneuvering operation of the work machine. Detection means 128 may be connected to a dash board including control joysticks, actuating levers, control levers, control shifters, gear levers, gear shift levers, switching levers, shift knobs, or the like. Detection means 128 allow for receiving a user input regarding driving direction and desired ground speed or speed ratio. These values may be the actual engine speed.

Additionally illustrated are further consumers 130 representing parasitic losses of the work machine. Consumers 130 may, for example, be cooling fans of the engine 102, electrical alternators, and the like.

The engine speed sensor 118 feeds back an engine speed signal to engine speed controller 124 via signal line 132.

Engine speed controller 124 received an engine speed setting signal from engine speed setting unit 126 via signal line 134. Engine speed setting unit 126 received from detection means 128 via signal lines 136 a desired ground speed signal. The desired ground speed signal may be operator commanded, or strategy commanded and provided from detection means 128. Further, via signal lines 138, engine speed setting unit 126 may receive additional engine speed setting information, for example depending on over temperature of the machine, battery status, decel pedal adjustments, variable under speed settings, for example for steering assistance, and the like.

When receiving a signal indicative of reverse driving operation from detection means 128 via signal line 136, engine speed setting unit 126 provides for a reduced engine speed setting signal provided to engine speed controller 124. Engine speed controller 124 compares the engine speed setting signal with the actual engine speed received from engine speed sensor 118 and reduces or increases engine 102. In case the actual engine speed is higher than the engine speed setting signal requires, the engine speed of engine 102 is reduced. In case the actual engine speed is lower than the engine speed setting signal requires, the engine speed of engine 102 is increased.

For setting the engine speed setting signal, engine speed setting unit 126 received via signal line 136 desired ground speed setting signals and via signal line 138 further engine speed setting signals.

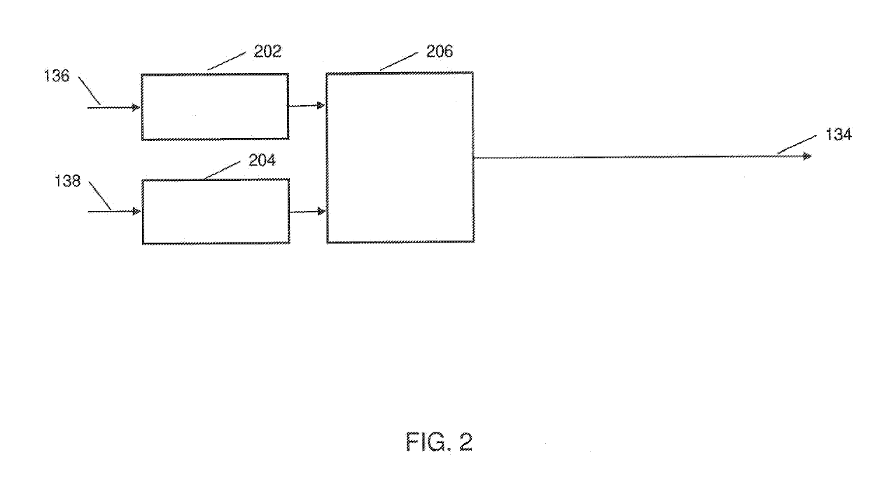

Engine speed setting unit 126 is illustrated in more detail within FIG. 2. FIG. 2 illustrates engine speed setting unit 126 with input signal lines 136, 138, and output signal line 134. Via input signal line 136, engine speed setting unit 126 receives desired ground speed setting signals. These signals may be operator commanded, and provided by detection means 128. Further, via signal line 136, engine speed setting unit 126 receives a signal indicative of a reverse maneuvering operation or a desired reverse maneuvering operation of the work machine.

Engine speed setting unit 126 puts out an engine speed setting signal via signal line 134. For calculating the output engine speed setting signal, engine speed setting unit 126 comprises a first engine speed selection unit 202 and a second speed selection unit 204. Upon receiving a reverse driving signal or a signal indicative of reverse driving, first engine speed selection unit 202 may reduce its output engine speed setting signal, for example from 2000 rpm to 1700 rpm.

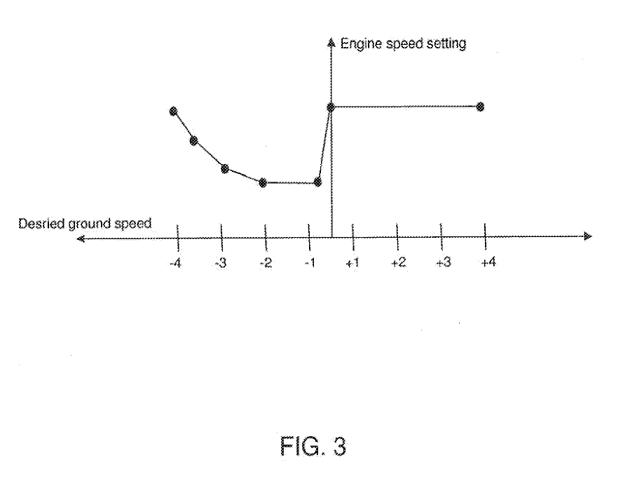

Depending on the desired ground speed setting received from signal line 136, the output engine speed setting signal is calculated, as illustrated in FIG. 3. As can be seen in FIG. 3, the engine speed setting signal is illustrated versus the desired ground speed setting. The desired ground speed setting signal is received within first engine speed selection unit 202. For example, for forward motion, desired ground speeds +1, +2, +3, +4 require an output engine speed setting signal of 2000 rpm. When receiving a negative desired ground speed setting, indicative of reverse driving, the engine speed setting signal may first be reduced to 1700 rpm. Upon increasing the desired ground speed setting in reverse direction, the engine speed setting signal may be increased because of pump flow limit, This is to achieve original runout travel speed of the machine. The graph of FIG. 3 mapping the desired ground speed setting into engine speed setting is adjustable and can be adjusted to current needs. It may also happen that the engine speed setting signal is already reduced in neutral.

When reducing the engine speed setting from 2000 rpm to 1700 rpm upon reception of a reverse driving signal, the engine 102 is driven with less rotational speed, and less power consumption may be obtained. It has been found that in reverse driving situations, hydraulic motor 110 requires only reduced energy, as worktools 114 may be inoperative. The power provided by engine 102 can be consumed by pump 106 and motor 112 for the drive system 116. This results in a ground speed, which equals the desired ground speed even at a reduce engine speed.

For increasing the tuneability of the hydraulic system 100, second engine speed selection unit 204 may receive via signal line 138 additional engine speed setting signals. The output of the engine speed selection units 202, 204 is provided to comparator 206. Within comparator 206, the two engine speed setting signals received from engine speed selection units 202, 204 may be compared, and the lowest value may be passed through. For example, comparison unit 206 may apply a minimum function onto the input signals.

The output of comparison unit 206 may be provided as an engine speed setting signal on signal line 134.

With reference to FIG. 1, detection means 128 may receive user commanded desired speed setting, also known as dash speed settings. In order to transfer the dash speed settings into an appropriate ground speed, where a reverse dash speed setting equals the same ground speed as a forward dash speed setting which is equal in absolute value, it is desirable to map the dash speed setting into a corresponding ground speed setting.

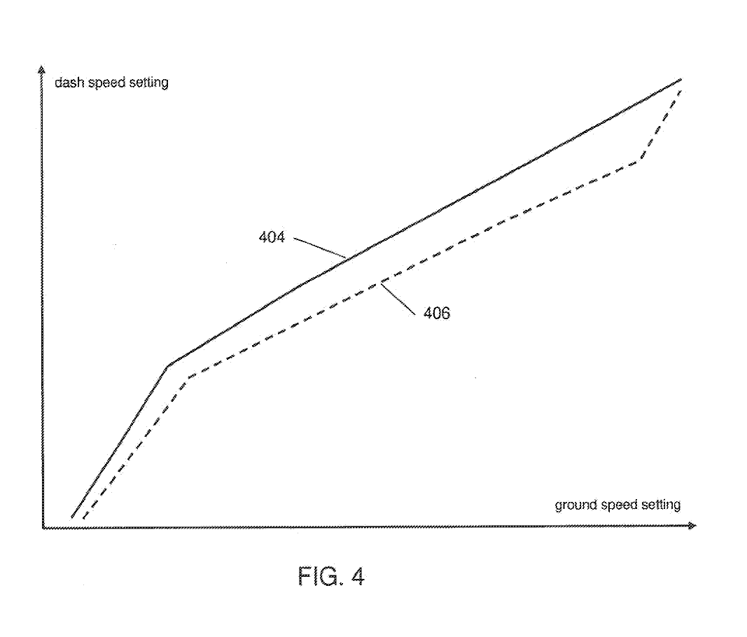

As is illustrated in FIG. 4, a graph allows for mapping a dash speed setting signal into a ground speed setting signal, which mapping may be employed within detection means 128. As illustrated a dash speed setting signal may be mapped into a corresponding ground speed setting signal. Graph 404 may be the mapping instruction for forward motion. Graph 406 may be the mapping instruction for reverse motion. A reverse dash speed setting results in a different ground speed setting according to graph 406 than a forward dash speed setting which is mapped according to graph 404. The graphs 404, 406 are tunable. For example, it is possible, to tune the dash speed setting to ground speed setting graph 406 for reverse motion in accordance with the desired ground speed to engine speed setting according to FIG. 3. It may also be possible to use a calculation for calculating a ground speed setting signal from a dash speed setting signal.

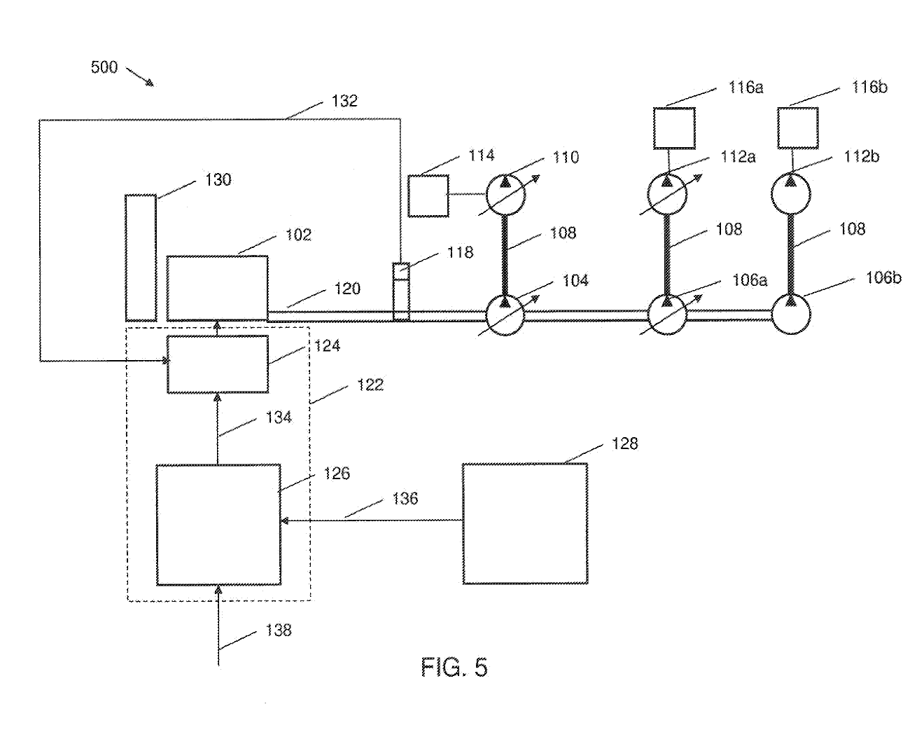

FIG. 5 illustrates a hydraulic system 500 being similar to a hydraulic system 100. Motor 112 for driving drive system 116, is now replaced by motors 112a, 112b. The first motor 112a drives a first drive system 116a and the second motor 112b drives a second drive system 116b. By providing two motors 112a, b for two drive systems 116a, b it is possible to drive the work machine with two independent axes.

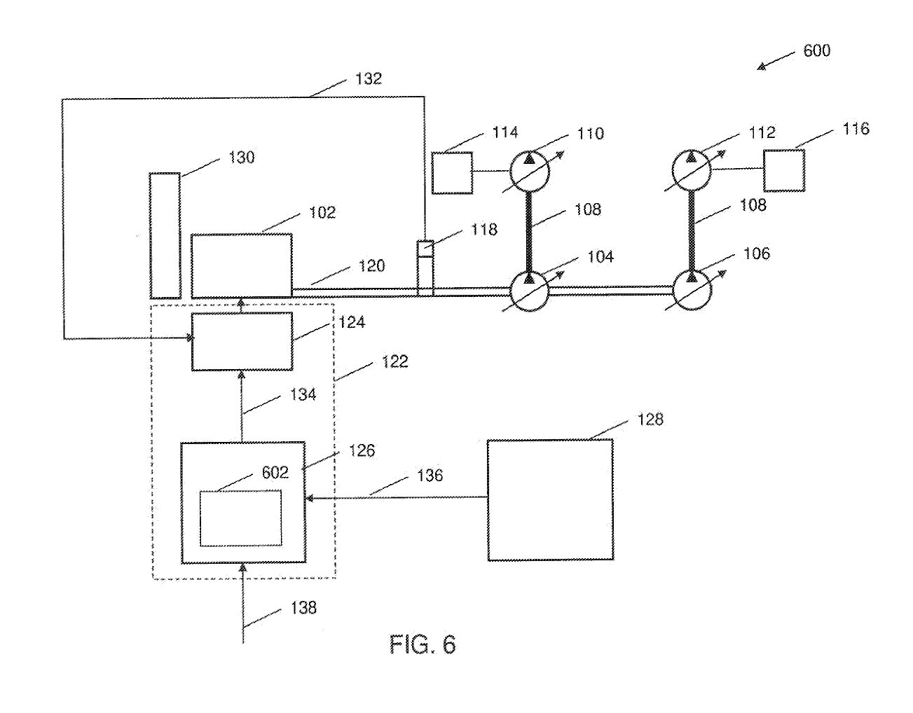

FIG. 6 illustrates a hydraulic system 600, similar to the hydraulic system 100. In addition to the hydraulic system 100, hydraulic system 600 comprises a rate limiter 602. Rate limiter 602 is included within engine speed setting unit 102. As has been described above, engine speed setting unit sets an engine speed setting signal in response to a desired ground speed setting signal received on signal lines 136, 138. Engine speed setting unit 126 may thus change the engine speed setting signal in response to changes to the input signals. The changes of the engine speed setting signal may be rate limited. For example, it is possible to rate limit the changes of the engine speed setting signal to +500 rpm per second for forward motion and −500 rpm per second for backward motion. Other rate limits are also possible. It is possible, to provide a rate limit as high as 2000 rpm per second.

### INDUSTRIAL APPLICABILITY

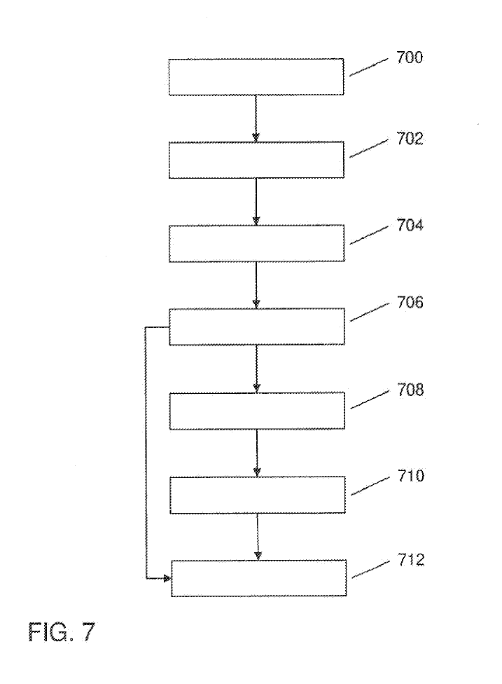

FIG. 7 illustrates a flowchart for operating hydraulic system 100.

When engine 102 is started (700), hydraulic system 100 is set into action. After start (700), detection means 128 may obtain (702), input via a dash board within the work machine, a desired ground speed signal. The desired ground speed signal is provided to engine speed setting unit 126. Within engine speed setting unit 126, the obtained desired ground speed signal is evaluated (704) as has already been described in conjunction with FIGS. 2, and 3. A resulting engine speed setting signal is output to engine speed controller 124. Within engine speed controller 124, the engine speed setting signal is compared (706) with the actual engine speed received via engine speed sensor 118 and an engine speed signal is set (712) for engine 102 in order to bring the actual engine speed into conformance with the desired engine speed.

When the operator chooses to put the work machine into backward motion, a signal indicative of the reverse maneuvering is detected (708) within detection means 128. Detection means 128 output a signal indicative of the desired reverse motion. This signal is received (710) within engine speed setting unit 126. Upon reception of this reverse operation signal, engine speed setting unit 126 sets (712) the engine speed in accordance with a graph illustrated in FIG. 3. For example, the engine speed setting signal may be reduced from 2000 rpm to 1700 rpm. Engine speed setting signal is further processed by engine speed controller 124 and in response to this signal engine 102 is operated at a reduced speed, i.e. at 1700 rpm instead of 2000 rpm.

In reverse motion, worktools 114 may require only reduced hydraulic power, as they may now be in reduced operation. Thus, even with the reduced engine speed hydraulic motor 112 may provide enough power to the drive system 116 to drive the work machine with appropriate ground speed. The operator does not notice that the engine 102 is driven at a reduced speed, as a ground speed is equal to the ground speed in forward motion. The engine 102 is operated at lower fuel consumption and reduced noise. As the engine 102 is operated with a reduced power, parasitic loses of consumers 130 may be reduced. For example, the engine fan may be operated at a reduced rate, as the engine needs less cooling. This may further reduce power losses, as parasitic losses of consumers are reduced in line with a reduction of power consumption of engine 102.

Although the preferred embodiments of this invention have been described herein, improvements and modifications may be incorporated without departing from the scope of the following claims.

1. An apparatus comprising:
control means for controlling a power output of an engine configured for propelling a machine; and
detection means for detecting a reverse driving direction operation of said machine;
said control means being arranged for controlling the power output of said engine in response to detecting said reverse driving direction operation.

2. The apparatus of claim 1, wherein said machine is a hydraulic pump of a work machine.

3. The apparatus of claim 2, wherein said hydraulic pump is arranged for driving a hydraulic system with a hydraulic actuator within said work machine.

4. The apparatus of claim 1, wherein said control means are arranged for controlling the power output by controlling an engine speed setting.

5. The apparatus of claim 1, wherein said control means are arranged for controlling the power output by reducing said engine speed setting.

6. The apparatus of claim 1, wherein said control means are arranged for controlling the power output by mapping at least one of
A) a desired ground speed setting;
B) a desired transmission speed ratio, into a corresponding engine speed setting.

7. The apparatus of claim 1, wherein said control means are arranged for controlling the power output by changing the engine speed setting with a rate limit.

8. The apparatus of claim 4, wherein said engine speed setting is a desired engine speed setting and further including comparison means arranged for comparing the desired engine speed setting with engine speed settings of at least one other engine speed setting source.

9. The apparatus of claim 8, wherein said at least one other engine speed setting source is one of:
A) an operator commanded engine speed setting;
B) an automatically driven idle engine speed setting;
C) a variable under speed setting.

10. A work machine comprising an apparatus of claim 1.

11. A work machine comprising control means for controlling a power output of a prime mover configured for operating a machine; and
detection means for identifying a reverse maneuvering operation of said machine;
said control means being arranged for setting the power output of said prime mover in response to identifying said reverse maneuvering operation.

12. A method comprising
controlling a power output of an engine propelling a machine;
detecting a reverse driving direction operation of said machine; and
reducing the power output of said engine in response to detecting said reverse driving direction operation.

13. The method of claim 12, wherein controlling the power output includes controlling an engine speed setting.

14. The method of claim 13, wherein controlling the power output includes reducing said engine speed setting.

15. The method of claim 12, wherein controlling the power output further includes mapping a desired ground speed setting into a corresponding engine speed setting.

16. The method of claim 13, further including rate limiting changes of said engine speed setting when controlling said power output.

17. The method of claim 12, further including comparing a desired engine speed setting with engine speed settings of at least one other engine speed setting source.

18. The method of claim 13, further including controlling said engine speed setting by mapping a user input dash speed setting into a desired ground speed setting.
